(19) United States
(12) Patent Application Publication
(10) Pub. No.: US 2010/0215156 A1
(43) Pub. Date: Aug. 26, 2010

(54) STRUCTURAL DATA TRANSMISSION METHOD AND SYSTEM FOR INTERACTIVE VOICE RESPONSE SYSTEM

(75) Inventor: Chung Yo SUN, Zhudong Township (TW)

Correspondence Address: EGBERT LAW OFFICES, 412 MAIN STREET, 7TH FLOOR, HOUSTON, TX, 77002, US

(73) Assignee: INDUSTRIAL TECHNOLOGY RESEARCH INSTITUTE, Hsinchu (TW)

(21) Appl. No.: 12/774,232

(22) Filed: May 5, 2010

Related U.S. Application Data
(63) Continuation-in-part of application No. 11/400,109, filed on Apr. 6, 2006.

(30) Foreign Application Priority Data
Jun. 29, 2009 (TW) 098121772

(51) Int. Cl. H04M 1/64

(52) U.S. Cl. 379/88.04

(57) ABSTRACT

A structural data transmission method for an interactive voice response comprises the following steps: converting structural data provided by an interactive voice response server to an input program executed by a communication device; downloading the input program to the communication device; encoding the input data provided by the input program into a transmission instruction and transmitting the encoded instruction to an interactive voice response server; and decoding the encoded instruction received by the interactive voice response server.

### CROSS-REFERENCE TO RELATED APPLICATIONS

This application is a Continuation-In-Part (CIP) Application of U.S. patent application Ser. No. 11/400,109 filed on Apr. 6, 2006, the disclosure of which is incorporated herein by reference.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The disclosure relates to an interactive voice response system, and more particularly, to a structural data transmission method and a system for an interactive voice response system.

2. Description of Related Art Including Information Disclosed Under 37 CFR 1.97 and 37 CFR 1.98.

At present, the development of web pages provides users with convenient systems for data input. With the advantage of larger display, and the ability for users at home to transmit structural data to a host over the internet without the extra expenses, Inputting data on the web page is more applicable to personal computers than to mobile devices. However, many users use mobile phones as their primary communication devices. When such users need to transmit structural data to a host in real-time, several approaches may be taken. For instances, users can fill out the data on a web page, customer service personnel can record the data through telephone calls and store the data into a computer, users can send a custom specified short message to a computer system and save them in a computer database, users can manually write down the data, which are stored in a computer by other personnels, or users can connect an interactive voice response system and input the data by following the instruction provided by the interactive voice response system.

However, there are many shortcomings to the above methods. For example, web pages are designed for personal computers. If a mobile phone is used for data transmission by internet, the display makes the operation very inconvenient, and there is a risk of disconnection during the data transmission process. In addition, for a mobile phone used for data transmission by internet, data transmission fee is required for the internet connection.

U.S. Pat. No. 7,027,571 provides a system. When a user dials from a telephone to an interactive voice response system, the interactive voice response system transmits the display menu to a personal digital assistant (PDA) held by the user. The user can make choices on the menu provided by the PDA. After the interactive voice response system receives the user's data, it sends the next menu to the PDA. This process is repeated until the required service is available, and then the required service can be supplied. However, the aforementioned system requires connection through computer network and it is not applicable to environments without internet access.

U.S. Pat. No. 7,263,177 also provides a system, which combines two interactive voice response systems to provide an integral service. When the first interactive voice response system receives a telephone call from a user, the system utilizes the second interactive voice response system to provide additional media services, such as voice recognition function. In this way, the user can interact with the interactive voice response system directly by voice recognition technique.

According to the above description, it is essential to provide a structural data transmission method and system for an interactive voice response system such that data can be transmitted to a computer system in time.

### BRIEF SUMMARY OF THE INVENTION

One embodiment discloses a structural data transmission method for an interactive voice response system, comprising the steps of: converting structural data provided by an interactive voice response server to an input program executable by a communication device; downloading the input program to the communication device; encoding the data provided by the input program into an instruction and transmitting the instruction to an interactive voice response server; and decoding the instruction received by the interactive voice response server.

Another embodiment discloses a structural data transmission system for an interactive voice response system, comprising an interactive voice response server, a delivery server and a service server. The interactive voice response server is configured to provide structural data and receive encoded data from a communication device. The delivery server is configured to provide the communication device with an input program converted from the structural data by the interactive voice response server, wherein the input program is executed in the communication device to encode a transmission instruction. The service server is configured to decode the data received by the interactive voice response server.

### BRIEF DESCRIPTION OF THE SEVERAL VIEWS OF THE DRAWINGS

The accompanying drawings, which are incorporated in and constitute a part of this specification, illustrate embodiments of the disclosure and, together with the description, serve to explain the principles of the disclosure.

FIG. 1 is a flowchart which illustrates an exemplary embodiment of the structural data transmission method for an interactive voice response system;

FIG. 2 illustrates a structural data transmission system for an interactive voice response system in accordance with an exemplary embodiment;

FIG. 3 illustrates a program editor function provided to a program developer in accordance with an exemplary embodiment;

FIG. 4 is a flowchart of generating an input program in accordance with an exemplary embodiment;

FIG. 5 is a flowchart of an exemplary embodiment of a structural data transmission system for an interactive voice response system; and

FIG. 6 is a flowchart of another exemplary embodiment of the structural data transmission system for an interactive voice response system.

### DETAILED DESCRIPTION OF THE INVENTION

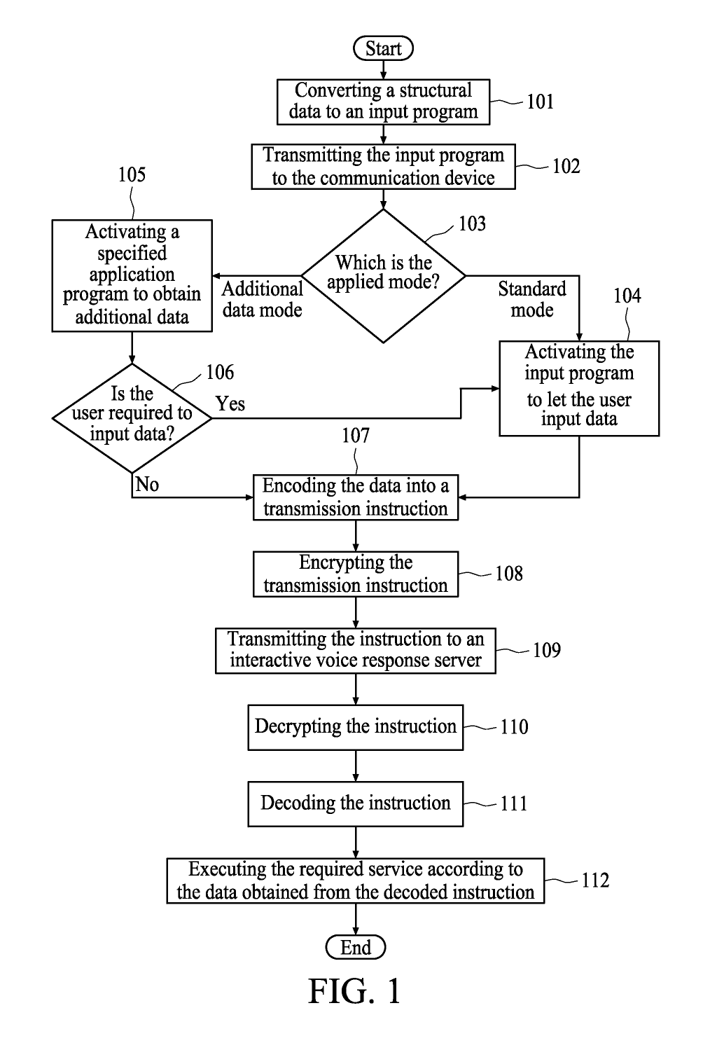

FIG. 1 is a flowchart which illustrates an exemplary embodiment of the structural data transmission method for an interactive voice response system. In this exemplary embodiment, a standard mode and an additional information mode are provided. In step 101, structural data provided by an interactive voice response server is converted to an input program executed by a communication device, and step 102 is executed. In step 102, the input program is transmitted to the communication device, and step 103 is executed. In step 103, the applied mode is chosen. If the standard mode is applied, step 104 is executed; otherwise, step 105 is executed. In step 104, the input program is executed, let the user input data, and step 107 is executed, wherein the input program is shown by a menu or by the question and the input field. In step 105, additional information is obtained by the communication device by activating a specified application program, such as a global positioning system, and step 106 is executed. In step 106, the program will determine whether the user needs to input the additional content. If the user is required to input the additional content, step 104 is executed; otherwise, step 107 is executed. In step 107, the data and any other additional content are encoded into an instruction code, and step 108 is executed. In step 108, the instruction code is encrypted, and step 109 is executed. In step 109, the instruction code is transmitted to an interactive voice response server, and step 110 is executed. In step 110, the instruction code is decrypted, and step 111 is executed. In step 111, the instruction code is decoded, and step 112 is executed. In step 112, the required service is performed according to the content obtained from the decoded instruction code.

As shown by the exemplary embodiment in FIG. 1, an encoding procedure is performed by the communication device after the user inputs the data. A call is then made by the communication device to the interactive voice response system. In this exemplary embodiment, the communication device may be a mobile communication device, such as a mobile phone, PDA, or other communication device such as a personal computer.

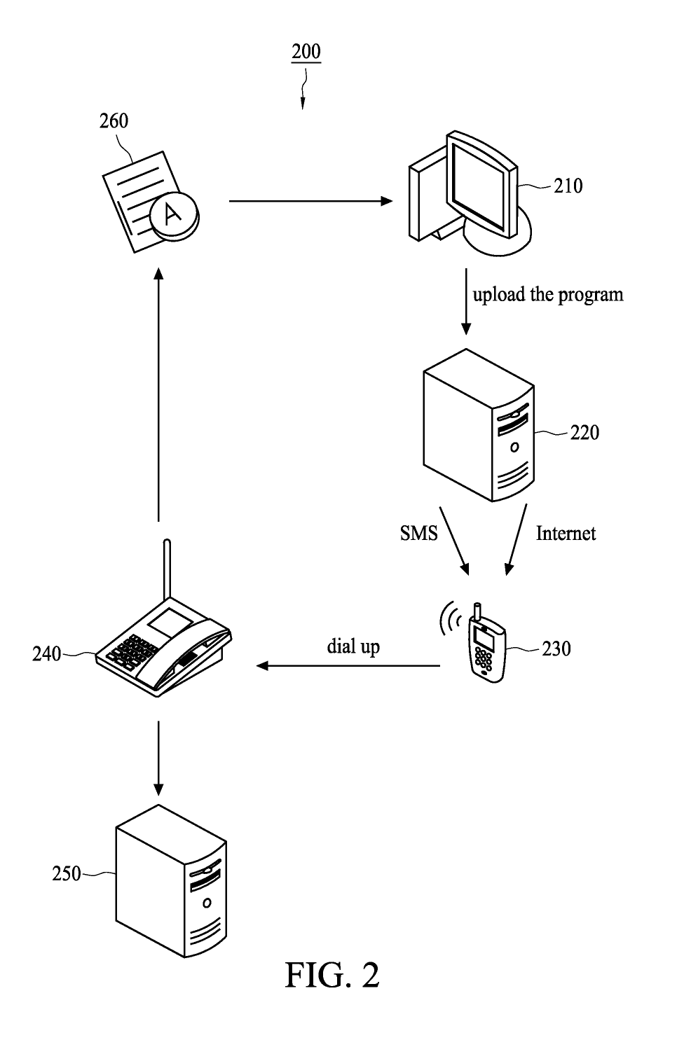

FIG. 2 illustrates the diagram of a structural data transmission system for an interactive voice response system in accordance with an exemplary embodiment. As shown in FIG. 2, the structural data transmission system 200 comprises a program developer 210, a delivery server 220, a communication device 230, an interactive voice response server 240 and a service server 250. The program developer 210 is configured to convert the structural data 260 provided by the interactive voice response server 240 to an input program executable by the communication device 230. The delivery server 220 is configured to save the input program and provide it to the communication device 230 for downloading. The input program may be downloaded by the short message service (SMS) or through the internet to the communication device 230. The communication device 230 is configured to start the input program for the user to input data, which is then encoded as an instruction code. The instruction code is transmitted to the interactive voice response server 240. The interactive voice response server 240 receives the instruction code and delivers it to the service server 250 for data processing. The service server 250 is configured to decode and decrypt the instruction code.

In some exemplary embodiments of this disclosure, the transmission instruction is a dialing-up instruction or a short message service text.

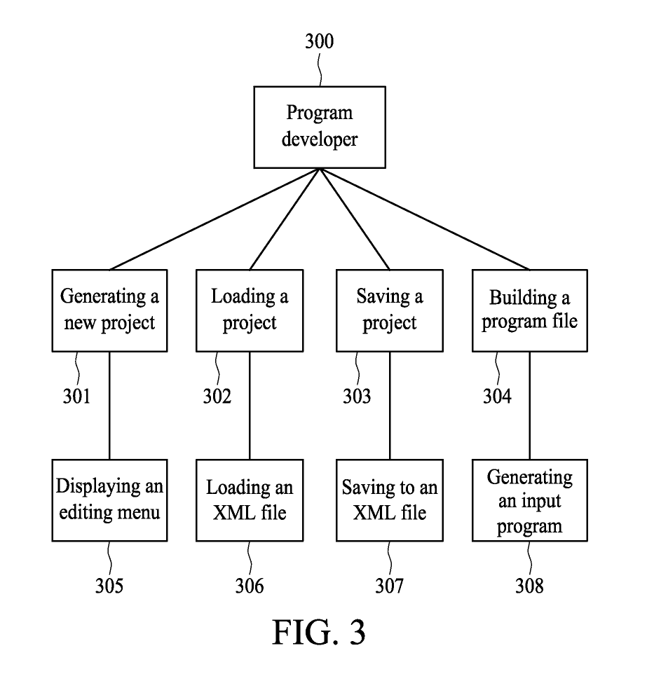

FIG. 3 illustrates the diagram of an editor function provided by a program developer. As shown in FIG. 3, the program developer 300 provides four functions, including generating a new project 301, loading a project 302, saving a project 303 and building a program 304. As shown by 305, when a new project is generated, the program developer 300 provides an editing menu for the user to easily edit structural data into a format required by a communication device. As shown by 306, when a project is loaded, an external program is utilized by the program developer 300 to edit a well-defined file in the extensible markup language (XML) format, such that the input program can easily be generated after loading the XML file. As shown by 307, when a project is saved, the program developer 300 saves the edited project in an XML file format. As shown by 308, in the input program file building function, the program developer 300 converts the structural data of the XML format into a program executable by the communication device 230. The program may be a JAR file, a SIS file, and an EXE file or other application program executable by a smart phone, such that the user can input data into the communication device 230.

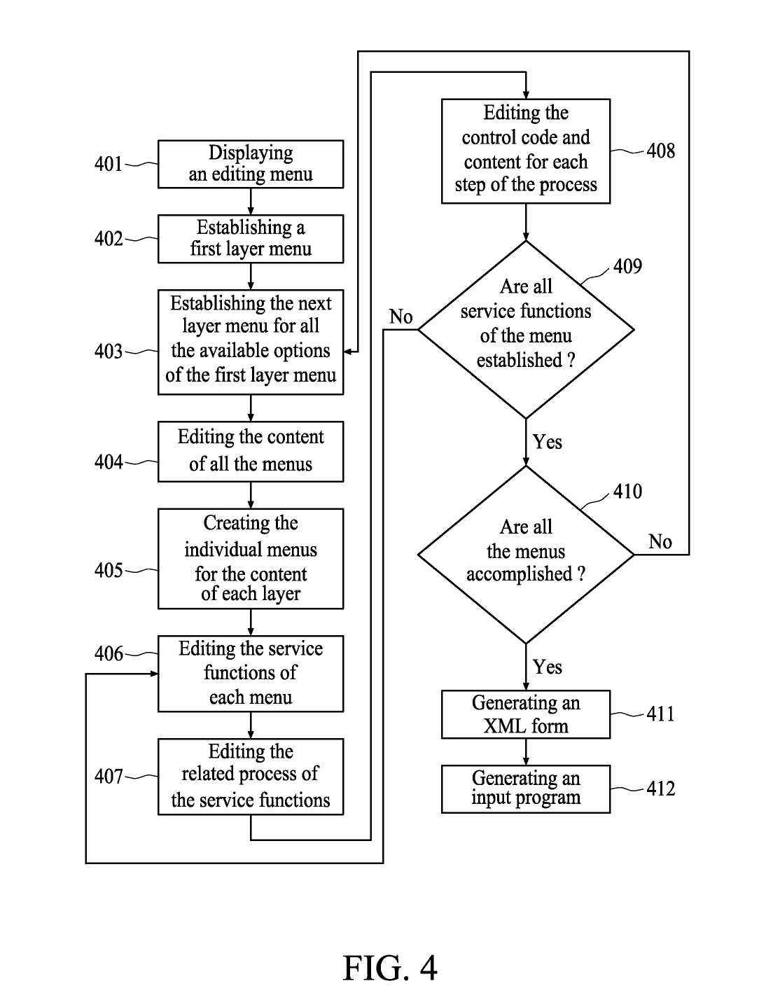

FIG. 4 illustrates the flowchart of a program developer generating the input program. In step 401, an editing menu is displayed, and step 402 is executed. In step 402, a first layer menu is established, and step 403 is executed. In step 403, the next layer menus for all the available options of the first layer menu are established, and step 404 is executed. In step 404, the content of all the menus are edited, and step 405 is executed. In step 405, the individual menus for the content of each layer are created, and step 406 is executed. In step 406, the service functions of each menu are edited, and step 407 is executed. In step 407, the related process of the service functions is edited, and step 408 is executed. In step 408, the control code and content for each step of the process are edited, and step 409 is executed. In step 409, whether all of the service functions of the menu are established? If all of the service functions of the menu have been established, step 410 is executed; otherwise, step 406 is executed. In step 410, whether all the menus are accomplished is determined. If all the menus are accomplished, step 411 is executed; otherwise, step 403 is executed. In step 411, an XML file or in any other file form readable for the program developer is generated, and step 412 is executed. In step 412, an input program executable by a communication device is generated.

As shown in FIG. 4, a program developer provides pull-down menus for each layer and generates contents for each menu. When a service function is edited, the related process and control code of standard instruction pertaining to a communication device can also be edited. After the editing of all of the service functions and contents of the menus are complete, the program developer generated an XML file. The program developer then generates the input program according to the XML file and provides it for the user to download.

In this exemplary embodiment, the program developer generates a JAVA program according to J2ME specification. Therefore, if a virtual machine is installed in the communication device, such as a smart phone, on which the JAVA program is executable, the smart phone can perform a dialing-up procedure by providing only one instruction code from the input program. In this exemplary embodiment, the input program is developed based on the libraries of JAVA MIDP 2.0 and CLDP 1.0.

Referring to FIG. 2, in this exemplary embodiment, the delivery server 220 receives the input programs uploaded by the program developer 210 and classifies the input programs based on the voice response categories. Therefore, when a user searches for an input program to download, he or she can select and download the required input program to the communication device 230. In addition, the delivery server 220 can record the users' download profile such that when a new version input program is available, users are informed by SMS text.

The communication device 230 features a Bluetooth communication function such that a user can download the input program onto a personal computer from the internet, and then store the input program into the communication device 230 by Bluetooth communication. Alternatively, the delivery server 220 can send an SMS text with a uniform resource locator (URL) of the input program to the communication device 230. A user can click on the URL to download the input program by wireless communication. After the input program is installed in the communication device 230, the input program may be displayed in a menu-driven manner. When the layer of the required service functions is reached, the communication device 230 converts the choices into an instruction code. Next, the communication device 230 connects to the interactive voice response server 240 by dialing-up or by sending a SMS text for the execution of the required service. In addition, the communication device 230 allows the user to save the instruction code as a shortcut in the database of the communication device 230. In this way, user can conveniently click on the shortcut and connect to the interactive voice response server 240 for the execution of the required service.

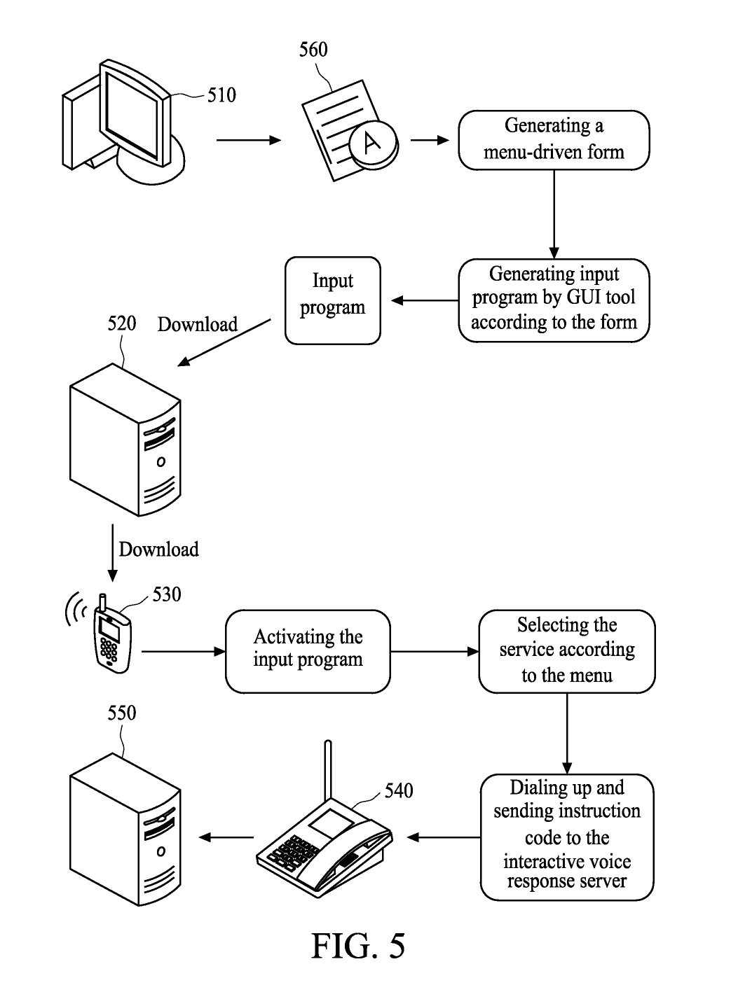

FIG. 5 illustrates an exemplary embodiment of the application of the method shown in FIG. 1 to the system shown in FIG. 2. A typical voice response system provides a hierarchical menu for the user to select a required service. The content of the voice response system, i.e., the content of each option, is converted to structural data and provided to a program developer 510. The program developer 510 converts the structural data to an XML file defined by the program developer 510 and the editing function of an external program. The program developer 510 then hierarchically generates a menu-driven form and saves it as an XML file. Afterward, the program developer 510 analyzes the XML file and generates an input program in a JAR file or a SIS file, or a file in other application format executable by a smart phone, such as an EXE file. The program developer 510 then uploads the input program to a delivery server 520. The input program can be downloaded and installed to a communication device 530 through the internet or by SMS. After the input program is activated, a menu-driven screen is displayed so that the user can select and input data. After all data is finished, the input program converts the input data into a instruction code and connects the communication device 530 to a interactive voice response server 540. The interactive voice response server 540 then interacts with the instruction code and sends the structural data provided by the user to a service server 550.

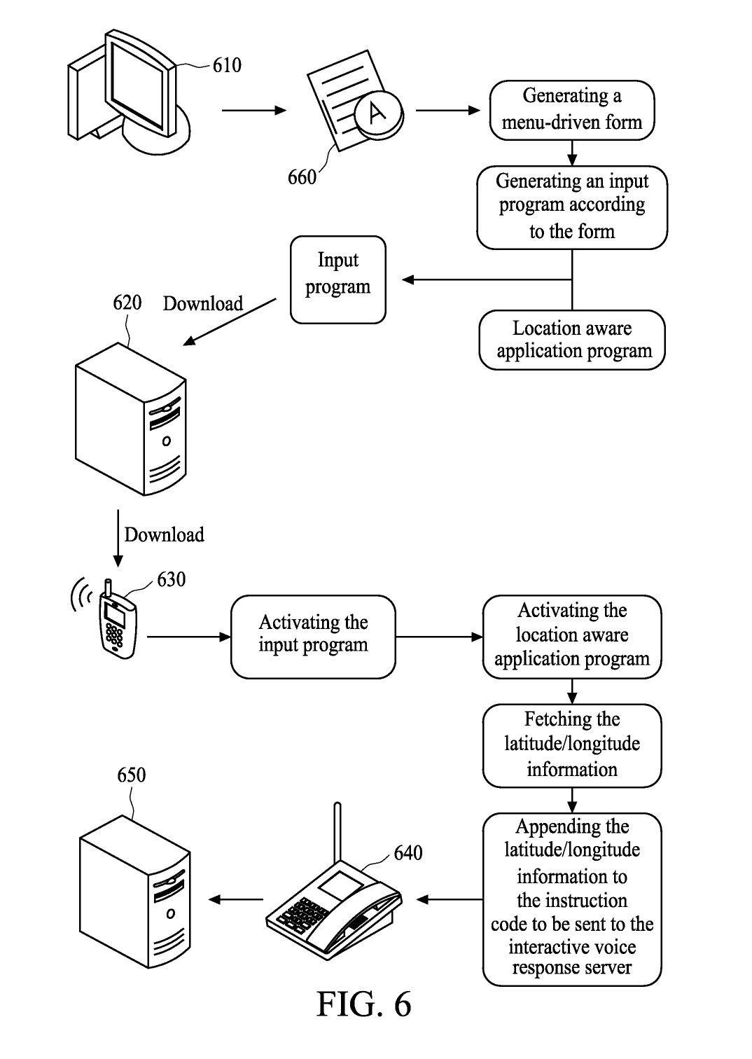

FIG. 6 illustrates another exemplary embodiment of the application of the method shown in FIG. 1 to the system shown in FIG. 2. The exemplary embodiment shown in FIG. 6 is similar to the exemplary embodiment shown in FIG. 5 with the difference of application mode. The exemplary embodiment shown in FIG. 5 refers to a standard mode, and the exemplary embodiment shown in FIG. 6 refers to an additional information data mode. As shown in FIG. 6, a program developer 610 integrates a specific application program, such as GPS, AGPS or Wi-Fi, into the input program. Before the menu-driven screen is displayed, a communication device 630 executes the specific application program to fetch additional information such as the GPS coordinates of the communication device 630, converts the information to a format compatible with the menu, and appends the information to the instruction code to be sent to the interactive voice response server 640.

In some exemplary embodiments of this disclosure, the specific application program is not included in the input program. In addition, the specific application program is not limited to applications of GPS, AGPS or Wi-Fi, but also includes other applications such as an environmental parameter monitoring application, e.g. temperature monitoring, humidity monitoring or physiological parameter monitoring.

An exemplary embodiment of a transmission instruction converted from structural data is shown as follows. The following is a hierarchical menu displayed when a user checks his or her saving account by making a telephone call to connect the call center of one bank. For simplicity, the following does not show the complete menu:

```
Bank service: press 3
    General inquiry: press 1
        Account inquiry: press 1
            Enter account number and password
        Transaction details inquiry: press 2
            Enter account number and password and the date interval
                Interest rate inquiry: press 3
                Currency exchange rate inquiry: press 4
```

According to the menu shown above, a user has to dial up the telephone number of the bank and sequentially enters 3, 1, 1, and account number and password after the call is connected. The interaction time between the user and the bank may require more than a few minutes. However, if the structural data transmission method and system for an interactive voice response system of this disclosure is applied, the instruction code may comprise a text string of:

(telephone number of the bank)p3p1p1(account number)#(password)

Since the required data have already been constructed, a user does not need to listen to the voice of the interactive voice response system, and thus the interaction time between the user and the bank can be reduced. Apparently, the interaction time between the user and the bank can be reduced to under one minute by using the instruction code.

If a shortcut instruction is adopted, the instruction code may comprise a text string of:

(telephone number of the bank)p501p311(account number)(password)#

The number 501 is a predetermined header defining a shortcut instruction. In this way, the remaining data following the number 501 is entered without interaction. For the same input data, the interaction time between the user and the bank can be further reduced to under half a minute by using the above instruction comprising a shortcut instruction.

The structural data transmission method and system for an interactive voice response system of this disclosure can be applied to various interactive voice response systems. The following exemplifies several applicable interactive voice response systems.

The structural data transmission method and system for an interactive voice response system of this disclosure can be applied to various types of hotline service system, such as a government construction hotline service system.

The structural data transmission method and system for an interactive voice response system of this disclosure can be applied to a real-time bus query system. Currently, most bus query systems provide information through the internet. However, it is not convenient for users to fetch this information due to some disadvantages, such as poor internet bandwidth in some areas or the high cost of network communication fee. By applying the structural data transmission method and system for an interactive voice response system of this disclosure, the code name of a bus and the road name can be constructed as a hierarchical menu, and an input program can be generated accordingly. In this way, by clicking on the menu, data can be transmitted to an interactive voice response system in real time and the bus status can be obtained directly.

The structural data transmission method and system for an interactive voice response system of this disclosure can be applied to a transportation arrangement system. Currently, a user can provide his or her location to customer service personnel when calling for a taxi, and then inquire with the customer service personnel for availability of nearby taxis. By applying the structural data transmission method and system for an interactive voice response system of this disclosure, a Wi-Fi or GPS application can be utilized first to obtain the user's coordinates, which are then sent to an interactive voice response system by the input program. Customer service personnel can then inform the user of the availability of a nearby taxi.

The structural data transmission method and system for an interactive voice response system of this disclosure can be applied to an outpatient appointment in a hospital. Currently, most outpatient appointments in hospitals require users to manually interact with an interactive voice response system or make it through the internet. By applying the structural data transmission method and system for an interactive voice response system of this disclosure, users can make it without connecting to the hospital through the internet. In addition, users do not have to interact with the IVR registration service of a hospital. The user only has to answer the questions of the menu-driven program of a mobile communication device. The program could quickly execute the telephone appointment through dialing-up the IVR of the hospital.

The structural data transmission method and system for an interactive voice response system of this disclosure can be applied to attending an outpatient appointment and waiting time query function. By applying the structural data transmission method and system for an interactive voice response system of this disclosure, the information of outpatients' progress can be accessed conveniently. After the required information for checking out the progress is finished, a call is dialed up to the interactive voice response system so that a user can follow up his or her appointment data and the progress. The IVR system can immediately inform the user of the progress and waiting time. In this way, users can arrival the hospital on time.

The structural data transmission method and system for an interactive voice response system of this disclosure can be applied to an enterprise reporting service. For an enterprise that includes a large number of stores or a large number of salesmen, the enterprise reporting process is tedious and expensive. By applying the structural data transmission method and system for an interactive voice response system of this disclosure, a standard form can be established for the input program to be executed on a communication device. In this way, salesmen can conveniently send their daily reports and the stocks of a warehouse to headquarters.

The structural data transmission method and system for an interactive voice response system of this disclosure can be applied to the listening to internet radio from the stations around the world. By applying the structural data transmission method and system for an interactive voice response system of this disclosure, all links to internet radio stations in the world can be integrated at a system service platform. All internet radio stations in the world can be categorized in a hierarchical menu. Anyone who connects to the system service platform could then have access to every internet radio station.

The structural data transmission method and system for an interactive voice response system of this disclosure can be applied to a location navigation system. Currently, most location data in mobile device are transmitted to the computer system through the internet. By applying the structural data transmission method and system for an interactive voice response system of this disclosure, a Wi-Fi or GPS receiver can be utilized to fetch the user's GPS coordinates, which are then sent to a system by the user's communication device. After the system receives a user's coordinates, it can generate a menu program comprising the information of the on-sale items around the user's location. The system then converts the menu-driven program into a URL which is sent to the user by SMS text. After the user clicks on the URL, the menu program can be downloaded. After the menu-driven program is started, the user can have the shopping guide for his or her location. The user then can listen to the shopping information and purchase the on-sale commodity immediately by the menu-driven program.

The structural data transmission method and system for an interactive voice response system of this disclosure can be applied to a time dollar service. A community or an organization can use the structural data transmission method and system for an interactive voice response system of this disclosure to issue a virtual currency for labor service or technical service. Users can store the required service, such as baby-sitting or house cleaning service, into a database of an information system through a phone call according to the techniques of disclosure. Besides, labor service provider can transmit the available time interval and affordable services to the information system by a menu operation according to the techniques of disclosure. The information system can find the exact matching on both sides and notify them to proceed the service.

In conclusion, the structural data transmission method and system for an interactive voice response system of this disclosure enables users to efficiently send data to an interactive voice response system by operating a menu on a communication device.

The above-described exemplary embodiments are intended to be illustrative only. Those skilled in the art may devise numerous alternative embodiments without departing from the scope of the following claims.

I claim:

1. A structural data transmission method for an interactive voice response system, comprising:
converting the structural data provided by an interactive voice response server to an input program executable by a communication device;
downloading the input program to the communication device;
encoding the content provided by the input program into an instruction code and transmitting it to the interactive voice response server; and
decoding the instruction code received by the interactive voice response server.

2. The structural data transmission method of claim 1, wherein the instruction code is a dialing-up instruction or a short message service text.

3. The structural data transmission method of claim 1, wherein the input program is shown by a menu or by the question and answering.

4. The structural data transmission method of claim 1, further comprising:
encrypting the instruction code by the communication device; and
decrypting the instruction code by the interactive voice response server.

5. A structural data transmission method for an interactive voice response system, comprising:
converting the structural data provided by an interactive voice response server to an input program executable by a communication device;
downloading the input program to the communication device;
triggering a specified application program to obtain additional information and starting the input program;
encoding the additional information and the content provided by the input program into an instruction code and transmitting it to the interactive voice response server; and
decoding the instruction code received by the interactive voice response server.

6. The structural data transmission method of claim 5, wherein the instruction code is a dialing-up instruction or a short message service text.

7. The structural data transmission method of claim 5, wherein the specified application program is a global positioning system.

8. The structural data transmission method of claim 5, wherein the specified application program is used to monitor an environmental parameter.

9. The structural data transmission method of claim 8, wherein the environmental parameter is the temperature, humidity or a physiological parameter.

10. The structural data transmission method of claim 5, wherein the input program is downloaded by the short message service or is downloaded through the internet to the communication device

11. The structural data transmission method of claim 5, further comprising:
encrypting the instruction code by the communication device; and
decrypting the instruction code by the interactive voice response server.

12. The structural data transmission method of claim 5, wherein the input program has a feature of providing a transportation arrangement and inquiry service.

13. The structural data transmission method of claim 5, wherein the communication device is a mobile communication device.

14. A structural data transmission system for an interactive voice response system, comprising:
an interactive voice response server, configured to provide structural data and receive encoded content from a communication device;
a delivery server, configured to provide the communication device with a downloadable program converted from the structural data provided by the interactive voice response server, wherein the program is executable by the communication device to generate an instruction code; and
a service server, configured to decrypt the encoded content received by the interactive voice response server.

15. The structural data transmission system of claim 14, further comprising:
a program developer, configured to convert the structural data to the input program.

16. The structural data transmission system of claim 14, wherein the input program is fetched by the short message service or downloaded through the internet to the communication device.

17. The structural data transmission system of claim 15, wherein the program developer provides functions of generating a new project, loading a project, saving a project and building a program file.

18. The structural data transmission system of claim 15 wherein the program developer generates an XML file according to the structural data.

19. The structural data transmission system of claim 14, wherein the instruction code comprises a shortcut instruction code.

20. The structural data transmission system of claim 14, wherein the input program has a feature of providing a hotline service.

21. The structural data transmission system of claim 14, wherein the input program has a feature of providing a transportation arrangement and inquiry service.

22. The structural data transmission system of claim 14, wherein the input program has a feature of providing an appointment service.

23. The structural data transmission system of claim 14, wherein the input program has a feature of providing a report service.

24. The structural data transmission system of claim 14, wherein the input program has a feature of providing a radio channel service.

25. The structural data transmission system of claim 14, wherein the input program has a feature of providing a location navigation service.

26. The structural data transmission system of claim 14, wherein the input program has a feature of providing a time dollar service.

27. The structural data transmission system of claim 14, wherein the instruction code is a dialing-up instruction or a short message service text.
